(19) United States
(12) Patent Application Publication
(10) Pub. No.: US 2026/0107870 A1
(43) Pub. Date: Apr. 23, 2026

(54) Air Entrainment Seed Accelerator

(71) Applicant: Precision Planting LLC, Tremont, IL (US)

(72) Inventors: Jeremy J. Hodel, Morton, IL (US); Keith T. Strang, Zimmerman, MN (US); Ryan Baker, Tremont, IL (US)

(21) Appl. No.: 19/105,171

(22) PCT Filed: Sep. 4, 2023
(86) PCT No.: PCT/IB2023/058731

§ 371 Date: Feb. 20, 2025

Related U.S. Application Data
(60) Provisional application No. 63/375,139, filed on Sep. 9, 2022.
(60) Provisional application No. 63/375,143, filed on Sep. 9, 2022.
(60) Provisional application No. 63/385,568, filed on Nov. 30, 2022.
(60) Provisional application No. 63/434,649, filed on Dec. 22, 2022.
(60) Provisional application No. 63/434,659, filed on Dec. 22, 2022.
(60) Provisional application No. 63/434,667, filed on Dec. 22, 2022.
(60) Provisional application No. 63/434,671, filed on Dec. 22, 2022.
(60) Provisional application No. 63/501,172, filed on May 10, 2023.
(60) Provisional application No. 63/504,352, filed on May 25, 2023.

(51) Int. Cl. A01C 7/08; A01C 7/04

(52) U.S. Cl. CPC A01C 7/082; A01C 7/046

(57) ABSTRACT

A seed-delivery device having a seed meter (128, 328) having a metering disc (202) configured to receive seeds, a seed tube (130, 330) coupled to the seed meter (128, 328), and a seed accelerator (200, 300) having an air inlet and a conduit, the conduit directing an air flow from the air inlet to the seed tube (130, 330) in a direction away from the seed meter (128, 328), the air flow configured to entrain and accelerate a seed in a direction away from the seed meter (128, 328) as the seed passes through the seed tube (130, 330).

### CROSS REFERENCE TO RELATED APPLICATIONS

This application claims priority to U.S. Application No. 63/375,139, filed on 2022 Sep. 9; U.S. Application No. 63/375,143, filed on 2022 Sep. 9; U.S. Application No. 63/385,568, filed on 2022 Nov. 30; U.S. Application No. 63/434,649, filed on 2022 Dec. 22; U.S. Application No. 63/434,659, filed on 2022 Dec. 22; U.S. Application No. 63/434,667, filed on 2022 Dec. 22; U.S. Application No. 63/434,671, filed on 2022 Dec. 22; U.S. Application No. 63/501,172, filed on 2023 May 10; U.S. Application No. 63/504,352, filed on 2023 May 25, all of which are incorporated herein by reference in their entireties.

### FIELD

Embodiments of the present disclosure relate generally to a seed delivery device.

### BACKGROUND

Agricultural row crop planters typically include a seed hopper connected to a seed metering system that delivers seeds into a furrow formed by disc opener blades. A plurality of these row crop planters are typically mounted in parallel along a tool bar which is attached to a tractor. For example, it is common to have four, sixteen, twenty-four, thirty-six, or even forty-eight row units attached to a single tractor.

Within a typical prior art row crop planter, seeds are delivered in bulk from the seed hopper to the metering system. The metering system singulates the bulk seeds and will most preferably provide these singulated seeds at very predictable and repeatable time intervals. The row crop planter subsequently delivers one seed at a time into the ground, typically into a furrow cut by the opener blades.

One common prior art method of seed delivery from the seed hopper to the ground is a gravity drop system that locates a seed tube inlet below the seed metering system. A singulated seed drops from the metering system down the seed tube and into a furrow prepared by opener blades disposed forward of the seed tube.

Crop yields are affected by a variety of factors, such as seed placement, soil quality, weather, irrigation, and nutrient applications. Seeds are typically planted in trenches formed by discs or other mechanisms of a planter row unit. Depth of seed placement is important because seeds planted at different depths emerge at different times, resulting in uneven crop growth. Spacing of seeds can affect yield because plants that are too close together compete for nutrients, and plants too far apart leave wasted space between them. Orientation of seeds can affect time to plant emergence, and therefore, uniformity of plant growth, as well as canopy closure and shading from adjacent plants. It would be beneficial to have improved methods of controlling the position and orientation of seeds placed in trenches so that seeds emerge and grow more uniformly.

There are several methods of orienting seeds for planting. Examples of orientation systems include PCT Publication Nos. WO2018013858A1, WO2018013859A1, WO2018013860A2, and WO2018013861A1. One particular type of seed orienter is described in U.S. Patent Publication No. US2020/0367425A1 and US2022/0192079A1, each which disclose a seed orientation coil. Seed is accelerated with air injected into the coil.

### BRIEF SUMMARY

In some embodiments, a seed-delivery device includes a seed meter having a metering disc configured to receive seeds, a seed tube coupled to the seed meter, and a seed accelerator having an air inlet, and a conduit directing an air flow from said air inlet to said seed tube in a direction away from said seed meter, said air flow configured to entrain and accelerate a seed passing through said seed tube from said seed meter.

The seed tube may have a generally cylindrical interior.

The metering disc may be configured to provide the seeds to the seed tube in a preselected orientation.

The seed tube may deliver seeds to a seed orientation device.

The seed orientation coil may include a curved seed path, and a pressurized air system to direct an air flow parallel to the curved path.

A row unit for planting seeds includes a frame configured to be coupled to a toolbar; a seed-trench opening assembly carried by the frame and configured to form a seed trench; a seed-delivery device carried by the frame and configured to deliver seeds to the seed trench, said seed-delivery device having a seed meter having a metering disc configured to receive seeds, a seed tube coupled to the seed meter, and a seed accelerator having an air inlet and a conduit, said conduit cone directing an air flow from said air inlet to said seed tube in a direction away from said seed meter, said air flow configured to entrain and accelerate a seed in a direction away from said seed meter as said seed passes through said seed tube; and a seed-trench closing assembly carried by the frame and configured to close the seed trench over seeds in the seed trench.

The seed tube may deliver seeds to a seed orientation device that is configured to orient the seeds prior to closing the seed trench.

The seed orientation device may include a curved seed path, and a pressurized air system to direct an air flow parallel to the curved path.

In one aspect, a method of planting with a row unit includes forming a seed trench in soil with the row unit, singulating seeds with a metering disc carried by the row unit, transferring singulated seeds from the metering disc to a first end of a seed tube, dispensing seeds from the second end of the seed tube, and closing the seed trench with a seed-trench closing assembly.

The seeds may be dispensed from the seed tube with a preselected orientation.

The seed may be oriented by a seed orientation assembly.

Other technical features may be readily apparent to one skilled in the art from the following figures, descriptions, and claims.

### BRIEF DESCRIPTION OF THE DRAWINGS

While the specification concludes with claims particularly pointing out and distinctly claiming what are regarded as embodiments of the present disclosure, various features and advantages may be more readily ascertained from the following description of example embodiments when read in conjunction with the accompanying drawings, in which:

FIG. 1 is a simplified side view of a row unit for planting;

FIG. 2 is a simplified projected view of a seed-delivery device that may be used in the row unit of FIG. 1, including a seed hopper, seed meter, and a seed tube;

FIG. 3 is a bottom view of the seed-delivery device of FIG. 2;

FIG. 4 is a cross-sectional view of the seed-delivery device of FIG. 2 taken along section line 4′ of FIG. 2 and looking toward the front side elevation;

FIG. 5 is a cross-sectional view of the seed-delivery device of FIG. 2 taken along section line 5′ of FIG. 2 and looking toward the left side elevation;

FIG. 6 is a cross-sectional view of the seed-delivery device of FIG. 2 also taken along section line 5′ of FIG. 2 but illustrated at a projected viewing angle;

FIG. 7 is a projected view of the seed tube of FIG. 2;

FIG. 8 is a simplified projected view of an alternative embodiment seed-delivery device that may be used in the row unit of FIG. 1, including a seed hopper, seed meter, and a seed tube;

FIG. 9 is a right side elevational view of the seed-delivery device of FIG. 8;

FIG. 10 is a cross-sectional view of the seed-delivery device of FIG. 8 taken along section line 10′ of FIG. 8 and looking toward the left side elevation;

FIG. 11 is a cross-sectional view of the seed-delivery device of FIG. 8 also taken along section line 10′ of FIG. 8 but illustrated at a projected viewing angle;

FIG. 12 is a left side elevational view of the seed tube of FIG. 8; and

FIG. 13 is a cross-sectional view of the seed tube of FIG. 12 taken along a vertical plane midway between the left and right sides and looking toward the left side elevation.

### DETAILED DESCRIPTION

All references cited herein are incorporated herein in their entireties. If there is a conflict between a definition herein and in an incorporated reference, the definition herein shall control.

Referring to the drawings, wherein like reference numerals designate identical or corresponding parts throughout the several views.

The illustrations presented herein are not actual views of any planter row unit or portion thereof, but are merely idealized representations to describe example embodiments of the present disclosure. Additionally, elements common between figures may retain the same numerical designation.

The following description provides specific details of embodiments. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all elements to form a complete structure or assembly. Only those process acts and structures necessary to understand the embodiments of the disclosure are described in detail below. Additional conventional acts and structures may be used. The drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may” with respect to a material, structure, feature, or method act indicates that such is contemplated for use in implementation of an embodiment of the disclosure, and such term is used in preference to the more restrictive term “is” so as to avoid any implication that other, compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the singular forms following “a,” “an,” and “the” are intended to include the plural forms as well, unless the context clearly indicates otherwise.

As used herein, the term “and/or” includes any and all combinations of one or more of the associated listed items.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures.

As used herein, the term “about” used in reference to a given parameter is inclusive of the stated value and has the meaning dictated by the context (e.g., it includes the degree of error associated with measurement of the given parameter).

As used throughout, ranges are used as shorthand for describing each and every value that is within the range. Any value within the range can be selected as the terminus of the range.

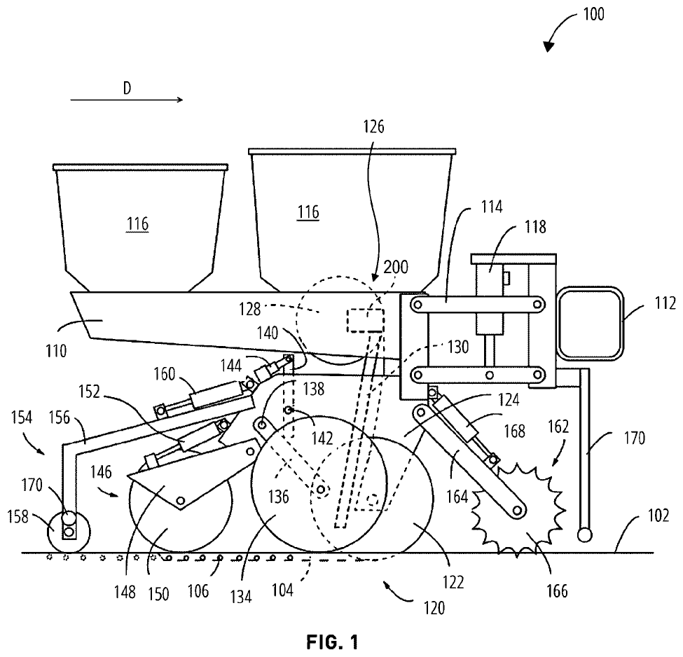

FIG. 1 illustrates an embodiment of an agricultural planter row unit 100. The row unit 100 has a frame 110 pivotally connected to a toolbar 112 by a parallel linkage 114, enabling each row unit 100 to move vertically independently of the toolbar 112 and of other row units 100. The frame 110 operably supports one or more hoppers 116, a downforce control system 118, a seed-trench opening assembly 120, a seed-delivery device 126, a seed-trench closing assembly 146, a packer wheel assembly 154, and a row cleaner assembly 162. The row unit 100 shown in FIG. 1 may be used with a conventional planter or with a central fill planter, in which latter case the hoppers 116 may be replaced with one or more mini-hoppers and the frame 110 modified accordingly as would be recognized by those of skill in the art.

The downforce control system 118 is disposed to apply lift and/or downforce on the row unit 100, such as disclosed in U.S. Pat. No. 9,408,337, “Agricultural Row Unit Apparatus, Systems and Methods,”granted Aug. 9, 2016.

The seed-trench opening assembly 120 includes a pair of opening discs 122 rotatably supported by a downwardly extending shank 124 of the frame 110. The opening discs 122 are arranged to diverge outwardly and rearwardly so as to open a V-shaped seed trench 104 in the soil 102 as the planter traverses the field in a forward direction D. In other embodiments, seed-trench opening assembly is described in U.S. Ser. No. 63/262,415, filed 12 Oct. 2021, and U.S. Ser. No. 63/262,417, filed 12 Oct. 2021.

The seed-delivery device 126 includes a seed meter 128 and a seed tube 130 that together may deliver seeds at a preselected rate to the soil 102. The seed meter 128 may be any commercially available seed meter, such as the fingertype meter or vacuum seed meter, such as the VSet® meter, available from Precision Planting LLC, 23333 Townline Rd, Tremont, Ill. 61568. Other exemplary seed meters are described in PCT Publication Nos. WO2012/129442, WO2016/077651, and WO2007/024646. The seed meter 128 may be configured to orient seeds in a preselected orientation to the seed tube 130 by any selected method, such as that shown and described in U.S. Patent Application Publication 2019/0230846, “Systems, Implements, and Methods for Seed Orientation with Adjustable Singulators During Planting,” published Aug. 1, 2019. In one embodiment, seed tube 130 can be longitudinally curved as described in U.S. Patent Application Publication 2019/0230846.

The seed tube 130 is positioned between the opening discs 122 to deliver seed from the seed meter 128 into the opened seed trench 104. The depth of the seed trench 104 is controlled by a pair of gauge wheels 134 positioned adjacent to the opening discs 122. The gauge wheels 134 are rotatably supported by gauge wheel arms 136, which are pivotally secured at one end to the frame 110 about pivot pin 138. A rocker arm 140 is pivotally supported on the frame 110 by a pivot pin 142. Rotation of the rocker arm 140 about the pivot pin 142 sets the depth of the seed trench 104 by limiting the upward travel of the gauge wheel arms 136 (and thus the gauge wheels 134) relative to the opening discs 122. The rocker arm 140 may be adjustably positioned via a linear actuator 144 mounted to the row unit frame 110 and pivotally coupled to an upper end of the rocker arm 140. The linear actuator 144 may be controlled remotely or automatically actuated as disclosed, for example, in U.S. Pat. No. 9,864,094, “System for Soil Moisture Monitoring,” granted Jan. 9, 2018.

A downforce sensor may be configured to generate a signal related to the amount of force imposed by the gauge wheels 134 on the soil 102. In some embodiments, the pivot pin 142 for the rocker arm 140 may comprise the downforce sensor, such as the instrumented pins disclosed in U.S. Pat. No. 8,561,472, “Load Sensing Pin,” granted Oct. 22, 2013.

The seed-trench closing assembly 146 includes a closing wheel arm 148 that pivotally attaches to the row unit frame 110. A pair of offset closing wheels 150 are rotatably attached to the closing wheel arm 148 and are angularly disposed to “close” the seed trench 104 by pushing the walls of the open seed trench back together over the deposited seed 106. An actuator 152 may be pivotally attached at one end to the closing wheel arm 148 and at its other end to the row unit frame 110 to vary the down pressure exerted by the closing wheels 150 depending on soil conditions. The seed-trench closing assembly 146 may be of the type disclosed in U.S. Pat. No. 9,848,524, “Agricultural Seed Trench Closing Systems, Methods, and Apparatus,” granted Dec. 26, 2017.

The packer wheel assembly 154 includes an arm 156 pivotally attached to the row unit frame 110 and extends rearward of the seed-trench closing assembly 146 and in alignment therewith. The arm 156 rotatably supports a packer wheel 158. An actuator 160 is pivotally attached at one end to the arm 156 and at its other end to the row unit frame 110 to vary the amount of downforce exerted by the packer wheel 158 to pack the soil over the seed trench 104.

The row cleaner assembly 162 may be the CleanSweep® system available from Precision Planting LLC, 23333 Townline Rd, Tremont, Ill. 61568. The row cleaner assembly 162 includes an arm 164 pivotally attached to the forward end of the row unit frame 110 and aligned with the seed-trench opening assembly 120. A pair of row cleaner wheels 166 are rotatably attached to the forward end of the arm 164. An actuator 168 is pivotally attached at one end to the arm 164 and at its other end to the row unit frame 110 to adjust the downforce on the arm to vary the aggressiveness of the action of the row cleaner wheels 166 depending on the amount of crop residue and soil conditions.

The row unit 100 may optionally carry other sensors 170. In some embodiments, for exemplary and non-limiting purpose, sensors 170 detect soil conditions before and/or after planting. In some embodiments, again for exemplary and non-limiting purpose, sensors 170 include sensors that monitor seed presence and flow, seed spacing, or other parameters useful to monitoring the proper operation of a seed orientation system.

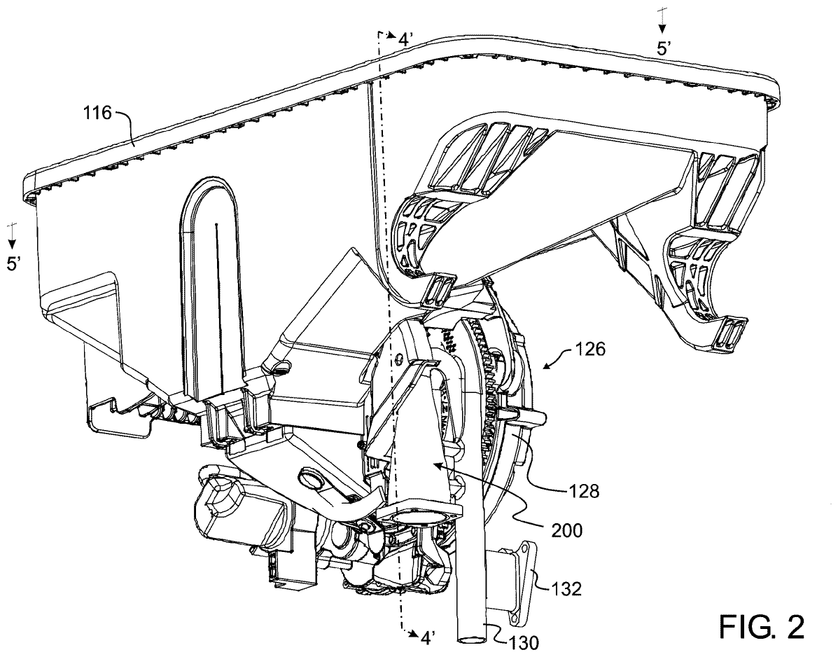

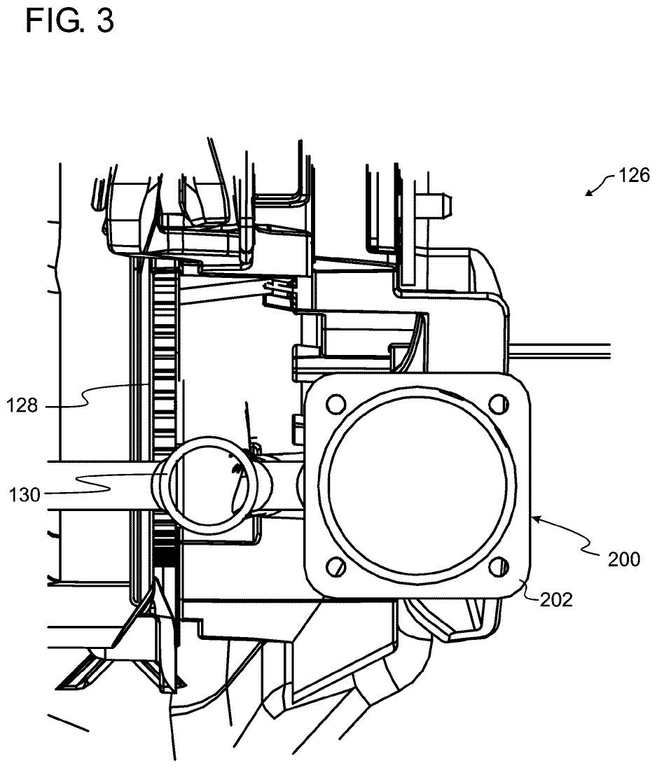

FIGS. 2-6 depict a preferred embodiment seed-delivery device 126. Seed-delivery device 126 includes seed hopper 116, seed meter 128, seed tube 130, and seed accelerator 200. Seed accelerator 200 has an air inlet coupler 202, a funnel 204, and a bend 206. One or more optional support braces 205 are provided to secure funnel 204 to seed tube 130, and seed tube 130 is optionally but preferably anchored to suitable supporting structure in the row unit through seed tube anchor 132.

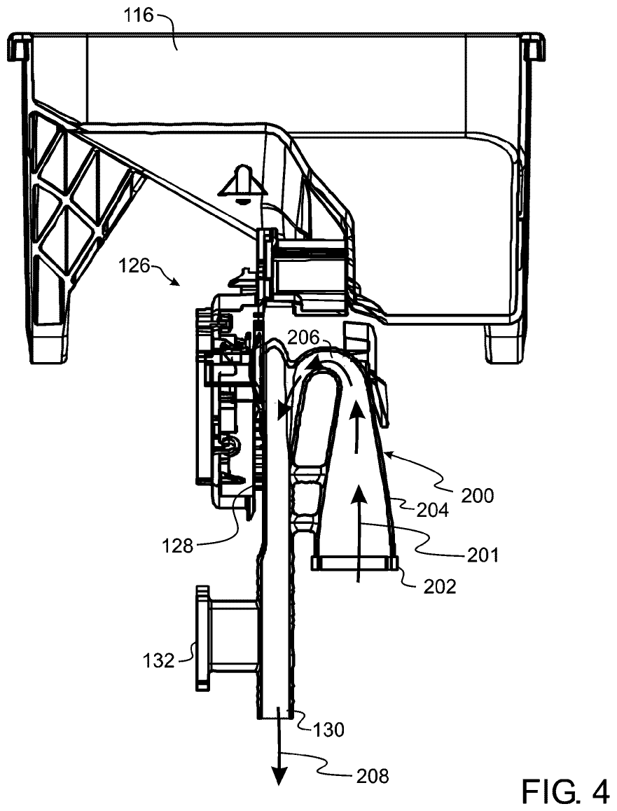

As illustrated in FIG. 4, positively pressurized air or other suitable fluid or gas enters air inlet coupler 202 in the direction indicated by air inlet flow arrow 201 and travels in the direction of the subsequent air flow arrows through funnel 204 and around bend 206 before entering into seed tube 130. Bend 206 directs the air stream into seed tube 130 in a direction generally away from seed meter 128, meaning the air stream will simultaneously entrain any seed within seed tube 130 and accelerate the seed through seed tube 130, ultimately defining a seed-entrained gas outlet direction as illustrated by arrow 208.

Pressure and flow of air or other fluid into air inlet coupler 202 can be controlled to achieve selected seed and air velocity. At slow ground speed, low air velocity is desired to prevent disturbing seeds once they are in the furrow. At high ground speeds, high seed velocity is desired to successfully trap seeds in a selected orientation. The seed velocity should be sufficiently greater than ground speed to make lateral motion of the seed relative to the ground negligible as the seed is being lodged into the furrow. In order to prevent backflow, relative cross sections and convexities of bend 206 and seed tube 130 can be tuned per venturi principles. Desirably, with proper air inlet pressure and proper dimensions within seed accelerator 200 including both cross-sectional area and angle of exit from bend 206 into seed tube 130, the flow of air shown from air inlet flow arrow 201 and in the direction of the subsequent air flow arrows and finally through seed tube 130 will in fact generate a slight vacuum at the seed entrance to seed tube 130, thereby improving the seed transfer from seed meter 128 to seed tube 130. Seed accelerator 200 can be designed and located relative to metering disc 202 at a point when a seed is released from vacuum on metering disc 202.

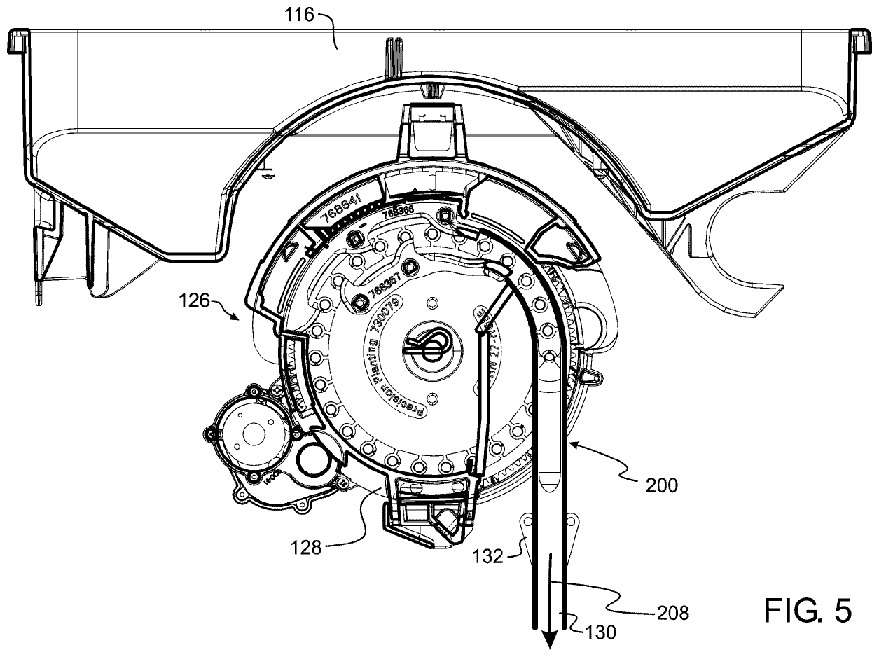

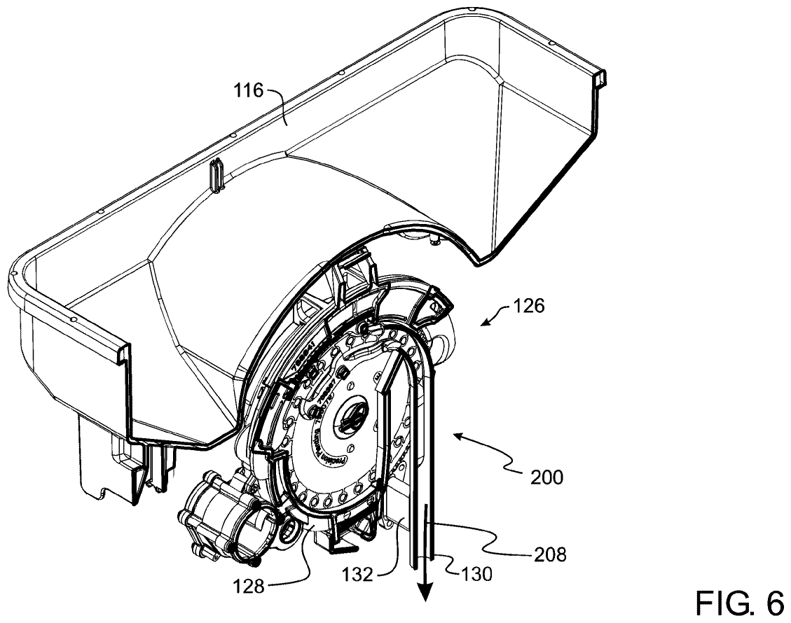

FIG. 5 illustrates seed meter 128 and seed tube 130 by cross-sectional view to reveal the junction between the interior face of seed meter 128 and seed tube 130. FIG. 6 illustrates seed meter 128 and seed tube 130 taken from a very similar cross section plane to that of FIG. 5, but illustrated from a different viewing angle. A metering disc rotates within seed meter 128 and receives seed from hopper 116. The metering disc has a plurality of holes spaced about a perimeter, and each hole is configured to each receive a single seed. As known in the art, the size and spacing of the holes may vary based on the type of seed to be planted. As the metering disc 202 rotates, it singulates and delivers one seed at a time from hopper 116 to seed tube 130.

Either or each of the seed meter 128, seed accelerator 200, and seed tube 130 may be configured to orient seeds in a preselected orientation to the seed tube 130 by any selected method. In some embodiments, seed meter 128 will be configured to orient seeds before or as they are delivered to seed tube 130. For example, seed meter 128 may include a vision system and a singulator with features (e.g., lobes) configured to orient seeds, such as shown in FIGS. 4A-4C of U.S. Patent Application Publication 2019/0230846, “Systems, Implements, and Methods for Seed Orientation with Adjustable Singulators During Planting,” published Aug. 1, 2019. In some embodiments, a separate seed orientation system is provided either adjacent the inlet to seed tube 130, intermediate along seed tube 130, or adjacent the outlet of seed tube 130. Suitable exemplary seed orientation apparatuses and systems are shown and described in U.S. Patent Application Publications 2020/0367425, entitled “Seed Orientation System for Agricultural Planters” and published Nov. 26, 2020, and 2022/0192079, entitled “Aerodynamic and Centrifugal Seed Orientation System for Agricultural Planters” and published Jun. 23, 2022. In alternative embodiments other types of seed orientation systems are used, including but not solely limited to those described in the background section herein above.

In some embodiments, seed tube 130 may be generally cylindrical with a generally cylindrical interior. In other embodiments, the seed tube 130 will have another shape, for exemplary and non-limiting purpose such as tapered to a smaller diameter at the bottom (seed exit) of the seed tube 130, or a non-cylindrical geometry.

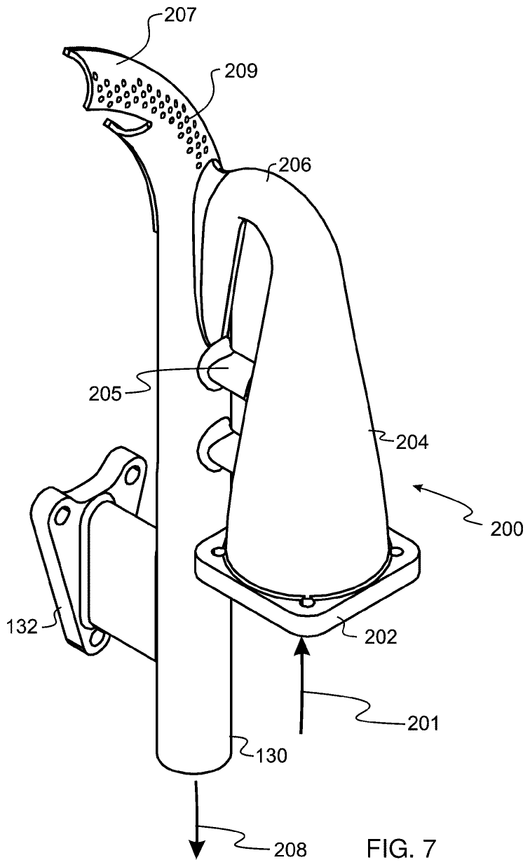

Seed accelerator 200 and seed tube 130 are illustrated separately from seed meter 128 in FIG. 7, providing a more clear and enlarged view thereof. As visible therein, a seed meter cover 207 is provided that preferably has a curvature approximating the curvature of the seed path within seed meter 128. Seed meter cover 207 allows seed coming directly off of a desired singulated seed spot within seed meter 128 to enter into seed tube 130, while any other seed or debris that might be in the vicinity of either the desired seed or the seed entrance to seed tube 130 will be deflected by seed meter cover 207.

Seed meter cover 207 may optionally, but preferably as illustrated, further contain one or as illustrated a plurality of vent holes 209. These vent holes 209 provide a pressure balancing between the gas pressure at the seed inlet of seed tube 130 and the surface of seed meter 128, to avoid disrupting the proper operation of seed meter 128 irrespective of transient pressure differentials therebetween. Vent holes 209 also provide a more gradual pressure differential, and when suitably located and dimensioned can provide benefit in reducing seed tumbling and rotational instability.

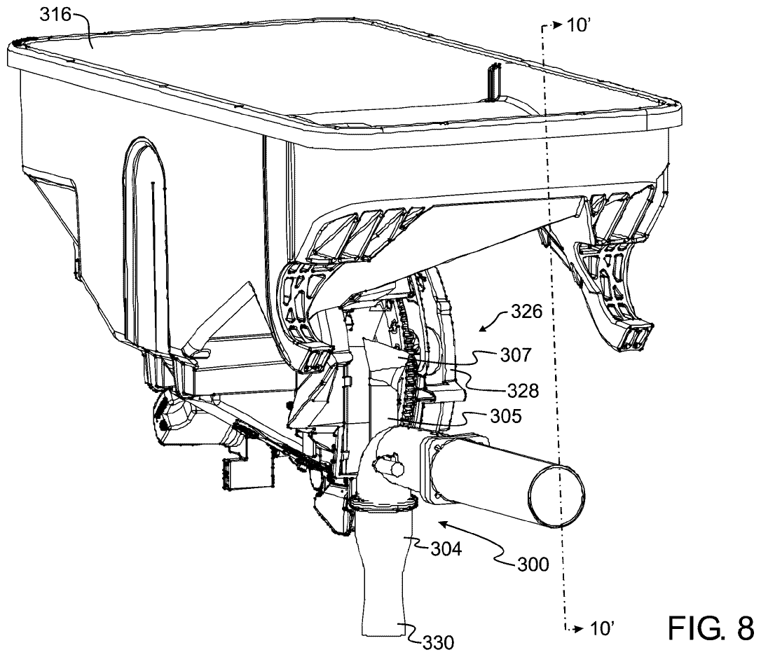

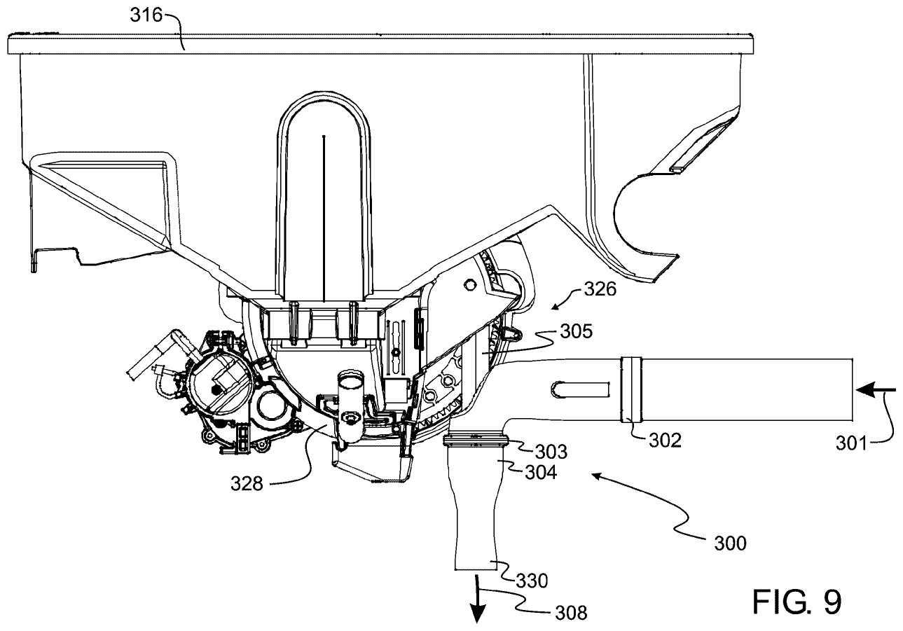

FIGS. 8-11 depict an alternative embodiment seed-delivery device 326. Seed-delivery device 326 includes seed hopper 316, seed meter 328, seed tube 330, and seed accelerator 300. Seed accelerator 300 has an air inlet coupler 302, a convergent entry cone 304, an optional venturi coupler 303 non-destructively removably coupling convergent entry cone 304 to the air inlet tube adjacent to air inlet coupler 302, a seed inlet tube 305 terminated by a seed meter inlet collector 307, and a cylindrical throat 306 that at the end most distal to seed meter 328 couples with seed tube 330. Seed tube 330 at the inlet end coupled with cylindrical throat 306 forms a divergent exit cone.

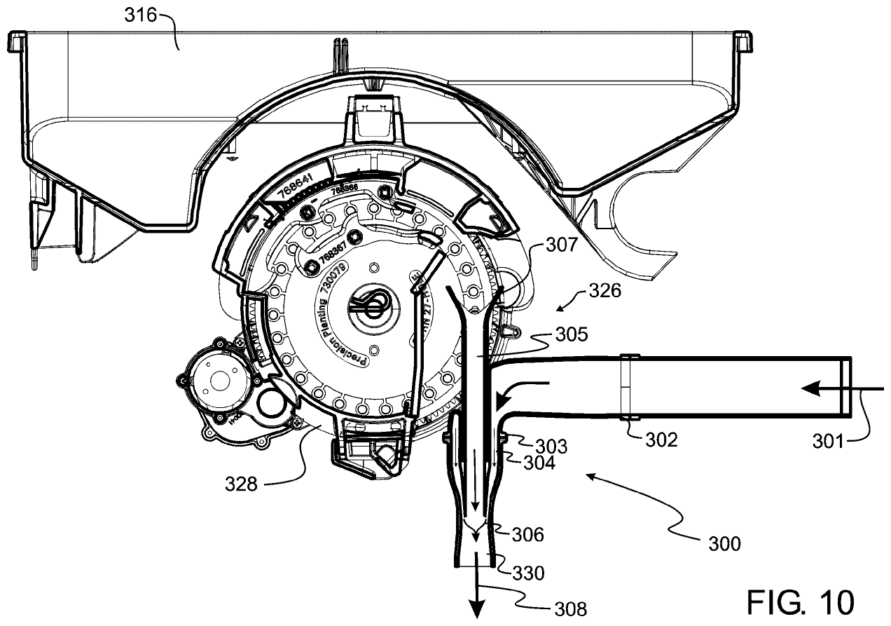

As illustrated in FIG. 10, positively pressurized air or other suitable fluid or gas enters air inlet coupler 302 in the direction indicated by air inlet flow arrow 301 and travels in the direction of the subsequent air flow arrows through entry cone 304. In one embodiment, seed inlet tube 305 is located centrally within entry cone 304, and the air inlet flow circumscribes seed inlet tube 305. In other embodiments, air inlet flow does not fully circumscribe seed inlet tube 305 and may include air nozzles or channels that insert air flow from selected directions. The air inlet flow passes through entry cone 304 into cylindrical throat 306 and passes the end of seed inlet tube 305 distal to seed meter 328 before entering into seed tube 330. Cylindrical throat 306 directs the air stream into seed tube 330 in a direction generally away from seed meter 328, meaning the air stream will simultaneously entrain any seed exiting from seed inlet tube 305, while simultaneously accelerating the seed through seed tube 330, ultimately defining a seed-entrained gas outlet direction as illustrated by arrow 308.

The pressure and flow of air or other suitable fluid into air inlet coupler 302 will preferably be controlled to achieve the desired seed acceleration as described above for air inlet coupler 202. Desirably, with proper air inlet pressure and proper dimensions within seed accelerator 300 including cross-sectional volume and angle of entrance defined by entry cone 304, difference in diameter between the exit of seed inlet tube 305 and cylindrical throat 306, and angle of exit from cylindrical throat 306 into seed tube 330, the flow of air shown from air inlet flow arrow 301 and in the direction of the subsequent air flow arrows and finally through seed tube 330 will in fact generate a slight vacuum at the seed entrance to seed inlet tube 305, thereby improving the seed transfer from seed meter 328 to seed inlet tube 305.

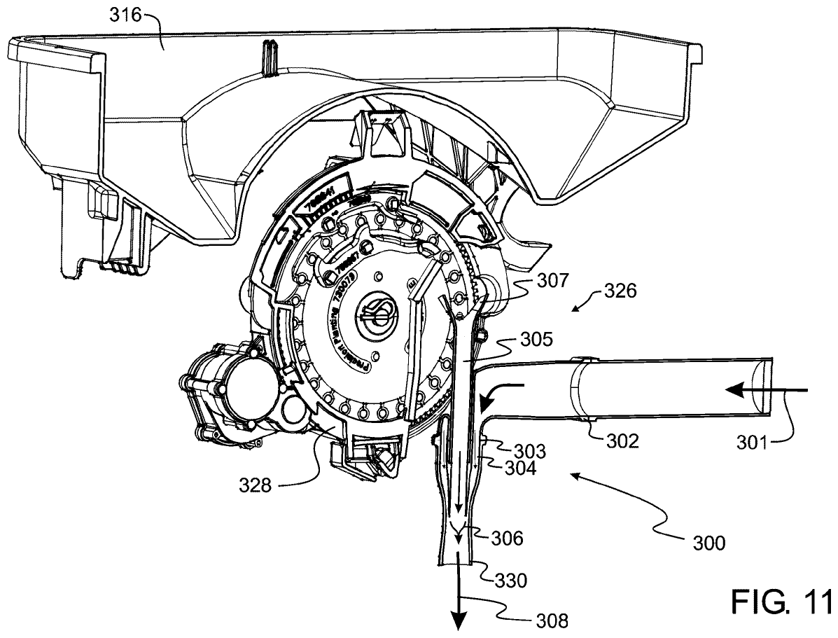

FIG. 10 illustrates seed meter 328 and seed inlet tube 305 by cross-sectional view to reveal the junction between the interior face of seed meter 328 and seed inlet tube 305. FIG. 11 illustrates seed meter 328 and seed inlet tube 305 taken from a very similar cross section plane to that of FIG. 10, but illustrated from a different viewing angle. A metering disc rotates within seed meter 328 and receives seed from seed hopper 316. The metering disc has a plurality of holes spaced about a perimeter, and each hole is configured to each receive a single seed. As known in the art, the size and spacing of the holes may vary based on the type of seed to be planted. As the metering disc rotates, it singulates and delivers one seed at a time from seed hopper 316 to seed inlet tube 305.

Either or each of the seed meter 328, seed accelerator 300, seed inlet tube 305, and seed tube 330 may be configured to orient seeds in a preselected orientation to the seed tube 330 by any selected method. In some embodiments, seed meter 328 will be configured to orient seeds before or as they are delivered to seed inlet tube 305. For example, seed meter 328 may include a vision system and a singulator with features (e.g., lobes) configured to orient seeds, such as shown in FIGS. 4A-4C of U.S. Patent Application Publication 2019/0230846, “Systems, Implements, and Methods for Seed Orientation with Adjustable Singulators During Planting,” published Aug. 1, 2019. In some embodiments, a separate seed orientation system is provided either adjacent the inlet to seed inlet tube 305, intermediate along seed inlet tube 305, intermediate along seed tube 330, or adjacent the outlet of seed tube 330. Suitable exemplary seed orientation apparatuses and systems are shown and described in U.S. Patent Application Publications 2020/0367425, entitled “Seed Orientation System for Agricultural Planters” and published Nov. 26, 2020, and 2022/0192079, entitled “Aerodynamic and Centrifugal Seed Orientation System for Agricultural Planters” and published Jun. 23, 2022. In alternative embodiments other types of seed orientation systems are used, including but not solely limited to those described in the background section herein above.

In some embodiments, both seed inlet tube 305 and seed tube 330 are generally cylindrical with a generally cylindrical interior. In other embodiments, either or both of seed inlet tube 305 and seed tube 330 are another shape, for exemplary and non-limiting purpose such as tapered to a smaller diameter at the bottom (seed exit) of the seed tube 330, or a non-cylindrical geometry.

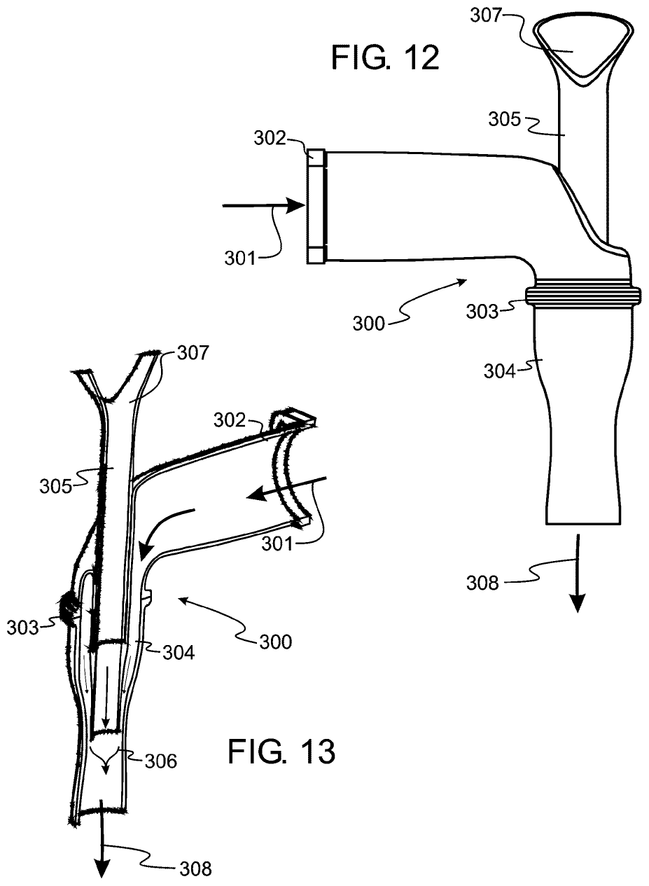

Seed accelerator 300 and seed tube 330 are illustrated separately from seed meter 328 in FIGS. 12 and 13, providing a more clear and enlarged view thereof. As visible therein, a seed meter inlet collector 307 is provided that collects singulated seeds from the seed path within seed meter 328. Seed meter inlet collector 307 allows seed coming directly off of a desired singulated seed spot within seed meter 328 to enter into seed inlet tube 305. Seed meter inlet collector 307 may optionally by provided with vent holes of similar geometry and function to vent holes 209, and for similar purpose and benefit.

### EXAMPLES

The following are nonlimiting examples.

Example 1—a seed-delivery device, comprising: a seed meter having a metering disc configured to receive seeds, a seed tube coupled to the seed meter, and a seed accelerator having an air inlet and a conduit, said conduit directing an air flow from said air inlet to said seed tube in a direction away from said seed meter, said air flow configured to entrain and accelerate a seed in a direction away from said seed meter as said seed passes through said seed tube.

Example 2—the seed-delivery device of Example 1, wherein said seed tube is longitudinally curved.

Example 3—the seed-delivery device of Example 2, wherein said seed tube comprises a generally cylindrical cross section interior passage.

Example 4—the seed-delivery device of Example 1, wherein said metering disc is configured to deliver seeds to said seed tube oriented in a preselected direction.

Example 5—the seed-delivery device of Example 1, further comprising a seed orientation device, wherein said seed tube delivers said seeds to said seed orientation device.

Example 6—the seed-delivery device of Example 5, wherein said seed orientation device comprises a curved seed path, and a pressurized air system to direct an air flow along said curved path.

Example 7—the seed-delivery device of Example 1, wherein said conduit is a divergent cone.

Example 8—the seed-delivery device of Example 7, wherein said seed accelerator further comprises a cylindrical throat between said convergent cone and said seed tube and a divergence subsequent to said cylindrical throat and coupled to said seed tube.

Example 9—the seed-delivery device of Example 8, further comprising a seed inlet tube having a first end adjacent to said seed meter and a second end distal to said first end and discharging into said cylindrical throat, said seed inlet tube configured to receive seed separating from a singulated seed spot within seed meter into said seed inlet tube.

Example 10—the seed-delivery device of Example 9, wherein said convergent cone and said cylindrical throat each circumscribe said seed inlet tube and define an air flow pathway therebetween.

Example 11—a row unit for planting seeds, comprising: a frame configured to be coupled to a toolbar; a seed-trench opening assembly carried by the frame and configured to form a seed trench; a seed-delivery device carried by the frame and configured to deliver seeds to the seed trench, said seed-delivery device having a seed meter having a metering disc configured to receive seeds, a seed tube coupled to the seed meter, and a seed accelerator having an air inlet and a conduit, said conduit directing an air flow from said air inlet to said seed tube in a direction away from said seed meter, said air flow configured to entrain and accelerate a seed in a direction away from said seed meter as said seed passes through said seed tube; and a seed-trench closing assembly carried by the frame and configured to close the seed trench over seeds in the seed trench.

Example 12—the row unit for planting seeds of Example 11, wherein said seed tube is longitudinally curved and comprises a generally cylindrical cross section interior passage.

Example 13—the row unit for planting seeds of Example 11, wherein said metering disc is configured to deliver seeds to said seed tube oriented in a preselected direction.

Example 14—the row unit for planting seeds of Example 11, further comprising a seed orientation device, wherein said seed tube delivers said seeds to said seed orientation device.

Example 15—the row unit for planting seeds of Example 14, wherein said seed orientation device comprises a curved seed path, and a pressurized air system to direct an air flow longitudinally along said curved path.

Example 16—the row unit for planting seeds of Example 14, wherein said conduit is a convergent cone.

Example 17—the row unit for planting seeds of Example 16, wherein said seed accelerator further comprises a cylindrical throat between said convergent cone and said seed tube and a divergence subsequent to said cylindrical throat and coupled to said seed tube.

Example 18—the row unit for planting seeds of Example 17, further comprising a seed inlet tube having a first end adjacent to said seed meter and a second end distal to said first end and discharging into said cylindrical throat, said seed inlet tube configured to receive seed separating from a singulated seed spot within seed meter into said seed inlet tube.

Example 19—the row unit for planting seeds of Example 18, wherein said convergent cone and said cylindrical throat each circumscribe said seed inlet tube and define an air flow pathway therebetween.

Example 20—a method of planting with a row unit, comprising the steps of: forming a seed trench in soil with the row unit; singulating seeds with a metering disc carried by the row unit; transferring singulated seeds from the metering disc to a first end of a seed tube; injecting air into an air inlet; converging said injected air in a conduit; dispensing seeds from the second end of the seed tube; entraining and accelerating said seed in said injected and converged air; and closing the seed trench with a seed-trench closing assembly.

Example 21—the method of planting with a row unit of Example 20, comprising the step of orienting said singulated seeds.

Example 22—the method of planting with a row unit of Example 21, wherein said step of orienting said singulated seeds occurs subsequent to said entraining and accelerating step.

Example 23—the method of planting with a row unit of Example 20, wherein said conduit is a convergent cone.

The foregoing description is presented to enable one of ordinary skill in the art to make and use the invention and is provided in the context of a patent application and its requirements. Various modifications to the preferred embodiment of the apparatus, and the general principles and features of the system and methods described herein will be readily apparent to those of skill in the art. Thus, the present invention is not to be limited to the embodiments of the apparatus, system and methods described above and illustrated in the drawing figures, but is to be accorded the widest scope consistent with the spirit and scope of the appended claims.

What is claimed is:

1. A seed-delivery device, comprising:
a seed meter having a metering disc configured to receive seeds,
a seed tube coupled to the seed meter, and
a seed accelerator having an air inlet and a conduit, said conduit directing an air flow from said air inlet to said seed tube in a direction away from said seed meter,
said air flow configured to entrain and accelerate a seed in a direction away from said seed meter as said seed passes through said seed tube.

2. The seed-delivery device of claim 1, wherein said seed tube is longitudinally curved.

3. The seed-delivery device of claim 2, wherein said seed tube comprises a generally cylindrical cross section interior passage.

4. The seed-delivery device of claim 1, wherein said metering disc is configured to deliver seeds to said seed tube oriented in a preselected direction.

5. The seed-delivery device of claim 1, further comprising a seed orientation device, wherein said seed tube delivers said seeds to said seed orientation device.

6. The seed-delivery device of claim 5, wherein said seed orientation device comprises a curved seed path, and a pressurized air system to direct an air flow along said curved path.

7. The seed-delivery device of claim 1, wherein said conduit is a divergent cone.

8. The seed-delivery device of claim 7, wherein said seed accelerator further comprises a cylindrical throat between said convergent cone and said seed tube and a divergence subsequent to said cylindrical throat and coupled to said seed tube.

9. The seed-delivery device of claim 8, further comprising a seed inlet tube having a first end adjacent to said seed meter and a second end distal to said first end and discharging into said cylindrical throat, said seed inlet tube configured to receive seed separating from a singulated seed spot within seed meter into said seed inlet tube.

10. The seed-delivery device of claim 9, wherein said convergent cone and said cylindrical throat each circumscribe said seed inlet tube and define an air flow pathway therebetween.

11. A row unit for planting seeds, comprising:
a frame configured to be coupled to a toolbar;
a seed-trench opening assembly carried by the frame and configured to form a seed trench;
a seed-delivery device carried by the frame and configured to deliver seeds to the seed trench, said seed-delivery device having
a seed meter having a metering disc configured to receive seeds,
a seed tube coupled to the seed meter, and
a seed accelerator having an air inlet and a conduit, said conduit directing an air flow from said air inlet to said seed tube in a direction away from said seed meter,
said air flow configured to entrain and accelerate a seed in a direction away from said seed meter as said seed passes through said seed tube; and
a seed-trench closing assembly carried by the frame and configured to close the seed trench over seeds in the seed trench.

12. The row unit for planting seeds of claim 11, wherein said seed tube is longitudinally curved and comprises a generally cylindrical cross section interior passage.

13. The row unit for planting seeds of claim 11, wherein said metering disc is configured to deliver seeds to said seed tube oriented in a preselected direction.

14. The row unit for planting seeds of claim 11, further comprising a seed orientation device, wherein said seed tube delivers said seeds to said seed orientation device.

15. The row unit for planting seeds of claim 14, wherein said seed orientation device comprises a curved seed path, and a pressurized air system to direct an air flow longitudinally along said curved path.

16. The row unit for planting seeds of claim 14, wherein said conduit is a convergent cone.

17. The row unit for planting seeds of claim 16, wherein said seed accelerator further comprises a cylindrical throat between said convergent cone and said seed tube and a divergence subsequent to said cylindrical throat and coupled to said seed tube.

18. The row unit for planting seeds of claim 17, further comprising a seed inlet tube having a first end adjacent to said seed meter and a second end distal to said first end and discharging into said cylindrical throat, said seed inlet tube configured to receive seed separating from a singulated seed spot within seed meter into said seed inlet tube.

19. The row unit for planting seeds of claim 18, wherein said convergent cone and said cylindrical throat each circumscribe said seed inlet tube and define an air flow pathway therebetween.

20. A method of planting with a row unit, comprising the steps of:
forming a seed trench in soil with the row unit;
singulating seeds with a metering disc carried by the row unit;
transferring singulated seeds from the metering disc to a first end of a seed tube;
injecting air into an air inlet;
converging said injected air in a conduit;
dispensing seeds from the second end of the seed tube;
entraining and accelerating said seed in said injected and converged air; and
closing the seed trench with a seed-trench closing assembly.

21. The method of planting with a row unit of claim 20, comprising the step of orienting said singulated seeds.

22. The method of planting with a row unit of claim 21, wherein said step of orienting said singulated seeds occurs subsequent to said entraining and accelerating step.

23. The method of planting with a row unit of claim 20, wherein said conduit is a convergent cone.
